(19) United States
(12) Patent Application Publication
(10) Pub. No.: US 2025/0180332 A1
(43) Pub. Date: Jun. 5, 2025

(54) SYSTEMS AND METHODS FOR TARGETED OPERATIONAL DISABLEMENT

(71) Applicant: Robotic Research OpCo, LLC, Clarksburg, MS (US)

(72) Inventors: Alberto Daniel Lacaze, Potomac, MD (US); Karl Nicholas Murphy, Cocoa Beach, FL (US)

(21) Appl. No.: 18/844,326

(22) PCT Filed: Mar. 2, 2023
(86) PCT No.: PCT/US2023/063627

§ 371 Date: Sep. 5, 2024

Related U.S. Application Data
(60) Provisional application No. 63/317,013, filed on Mar. 6, 2022.

(51) Int. Cl. F41G 9/00; B64U 50/13; B64U 60/00; B64U 101/18; G05D 1/46; G05D 1/656; G05D 105/35

(52) U.S. Cl. CPC F41G 9/00; B64U 50/13; G05D 1/46; G05D 1/656; B64U 60/00; B64U 2101/18; G05D 2105/35

(57) ABSTRACT

Systems and methods for targeted operational disablement that may utilize, for example, UAV-delivered shaped charges coupled to specific features of a target object. A UAV may navigate to, identify, and attach a disabling device to a critical component of a target such as a barrel of a tank main gun, a crew hatch cover, a tank tread, an engine compartment, or a magazine.

### CROSS-REFERENCE TO RELATED APPLICATIONS

Benefit and priority under 35 U.S.C. § 119(e) is hereby claimed to, and this is a Non-provisional of, U.S. Provisional Patent Application No. 63/317,013 filed on Mar. 6, 2022 and titled “SYSTEMS AND METHODS FOR TARGETED OPERATIONAL DISABLEMENT”, which is hereby incorporated by reference herein in the entirety.

### BACKGROUND

The destruction or disablement of war materiel has long been the source of great attention and much innovation. The enhancement of technologies that enable unmanned vehicles such as Unmanned Aerial Vehicle (UAV) devices (e.g., drones) and other Remote Control (RC) or autonomous vehicles (e.g., rovers) has provided for new opportunities to surveil and disrupt military operations. Attempts have predominantly focused on the usage of smaller UAV devices for enhanced surveillance or larger UAV devices for delivery of conventional weapon solutions to targets (e.g., a General Atomics MQ-1B Predator Remotely Piloted Aircraft (RPA) carrying and deploying a conventional AGM-114 “Hellfire” Air-to-Ground Missile (AGM) often carried by conventional fixed wing or rotary wing aircraft).

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a block diagram of a system according to some embodiments;

FIG. 2A, FIG. 2B, FIG. 2C, FIG. 2D, and FIG. 2E are perspective diagrams of a system according to some embodiments;

FIG. 3A and FIG. 3B are plan and perspective views of a system according to some embodiments;

FIG. 4 is a flow diagram of a method according to some embodiments;

FIG. 5 is a block diagram of an apparatus according to some embodiments;

FIG. 6A, FIG. 6B, FIG. 6C, FIG. 6D, and FIG. 6E are perspective diagrams of exemplary data storage devices according to some embodiments; and

FIG. 7 is flowchart of an algorithm according to some embodiments.

### DETAILED DESCRIPTION

### I. Introduction

While previous uses of UAV and other remote and/or autonomous vehicles have provided some valuable options for military operators, existing systems have failed to overcome operational deficiencies that limit their chances of successful mission completion. Most military targets are outfitted with defensive systems specifically designed to counteract likely threats, for example, which may significantly decrease success rates of conventional options. Conventional options are also quite expensive in both terms of financial cost as well as in terms of operational mobility and/or capacity of the delivering entity.

In a non-limiting example with respect to Main Battle Tank (MBT) vehicles, for example, most modern MBT vehicles employ defensive systems such as the “Trophy” Active Protection System (APS) of the Israeli Defense Force (IDF) that is designed to counteract conventional incoming projectile threats such as AGM devices, Rocket Propelled Grenade (RPG) devices, anti-tank rockets, and High-Explosive Anti-Tank (HEAT) rounds. Operational data suggests that such systems are capable of significantly reducing the effectiveness of many conventional anti-tank weapons. Anti-tank weapons that utilize a top-down attack (or “top attack”) engagement strategy such as the FGM-148 “Javelin” manufactured by Raytheon Technologies Corporation of Waltham, MA and Lockheed Martin Corporation of Bethesda, MD, may be capable of defeating many APS systems and are accordingly quite effective against MBT vehicles and other armored targets. The Javelin system is both heavy and expensive however, weighing in at just under fifty pounds (50-lbs) and with a cost of approximately two hundred thousand dollars ($200,000) per operational unit.

In accordance with embodiments herein, these and other deficiencies of previous solutions are remedied by providing systems, apparatus, methods, and articles of manufacture for targeted operational disablement. The inventors have realized, for example, that utilization of lower cost UAV devices to perform discrete and/or specifically-targeted operational disablement may both increase the chances of operational success as well as provide for much more portable and cost-effective solutions. According to some embodiments, for example, a UAV (and/or other remote and/or autonomous vehicle) may be utilized to (i) navigate to a location, (ii) search for and/or identify a target, (iii) search for and/or identify a particular feature of the target (e.g., a tank main gun barrel, a tank tread, engine compartment, fuel tank, munition, magazine, hatch, launch tube, etc.), (iv) maneuver to engage a coupling device with the target feature, and (v) activate a disablement device (e.g., shaped charge, thermite, etc.).

According to some embodiments, the utilization of a small form factor delivery device such as a drone (e.g., a Pegasus™ II or III transformable drone available from Robotic Research OpCp, LLC of Clarksburg, MD) that is programmed to identify and seek out specific target features and discretely deliver a disablement device to a target feature, may allow for significantly reduced costs as well as increased operational success rates. APS systems of armored vehicles are not designed to prevent against all attack vectors, for example, and a targeted operational disablement drone programmed and/or configured in accordance with embodiments herein may be able to exploit the operational limitation of such defensive measures. In some embodiments, the targeting and/or approach of the targeted operational disablement drone may be dynamically adjusted in the field and/or in real time to exploit identified weaknesses. In the non-limiting example of an MBT vehicle, for example, a targeted operational disablement drone may be programmed to seek out and attach (e.g., grab, grapple, fuse, adhere) to a distal end of the MBT main gun barrel. The distal end (or tip) of the main gun barrel is not typically considered a significant target warranting protection, for example, and accordingly may fall outside of the APS effective area (e.g., due to the geometry of the barrel extending the tip away from the body of the MBT). The activation of a shaped charge and/or introduction of thermite onto (and/or into) the distal end of the barrel, however, would disable the main gun of the MBT vehicle (e.g., until the barrel could be replaced). According to some embodiments, a flight (or travel) path and/or maneuver sequence of the UAV may be automatically selected and/or implemented to avoid and/or thwart APS interception and/or detection.

### II. Targeted Operational Disablement Systems

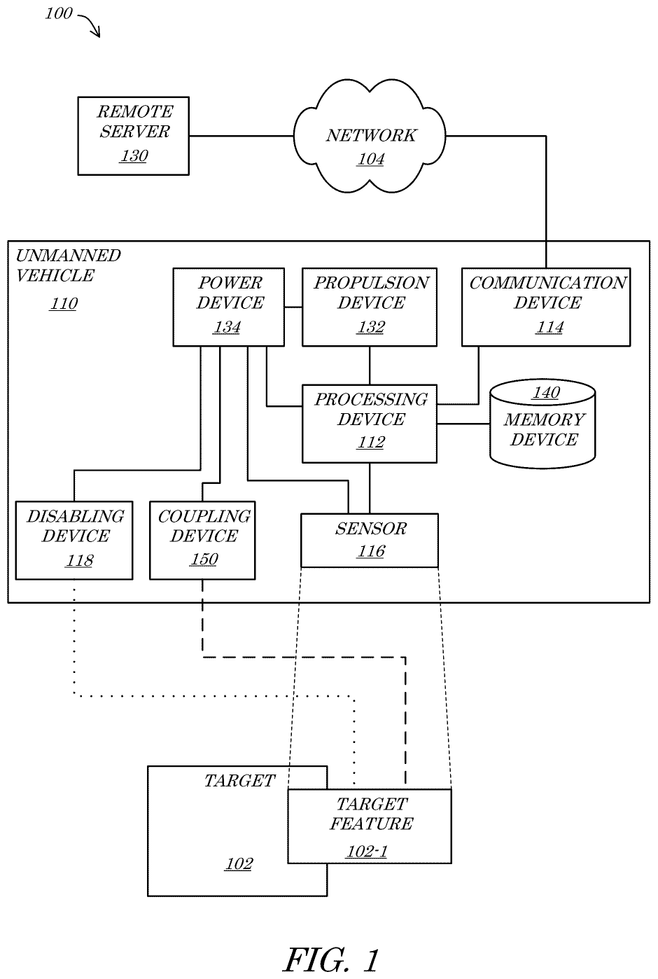

Referring first to FIG. 1, a block diagram of a system 100 according to some embodiments is shown. In some embodiments, the system 100 may comprise a target 102 (e.g., comprising a target feature 102-1), a network 104, and/or an unmanned vehicle 110. The unmanned vehicle 110 may comprise, for example, a processing device 112, a communication device 114, a sensor 116, and/or a disabling device 118. In some embodiments, the unmanned vehicle 110 may be in communication with, e.g., via the network 104, a remote server 130. According to some embodiments, the unmanned vehicle 110 may comprise a propulsion device 132, a power device 134, a memory device 140, and/or a coupling device 150.

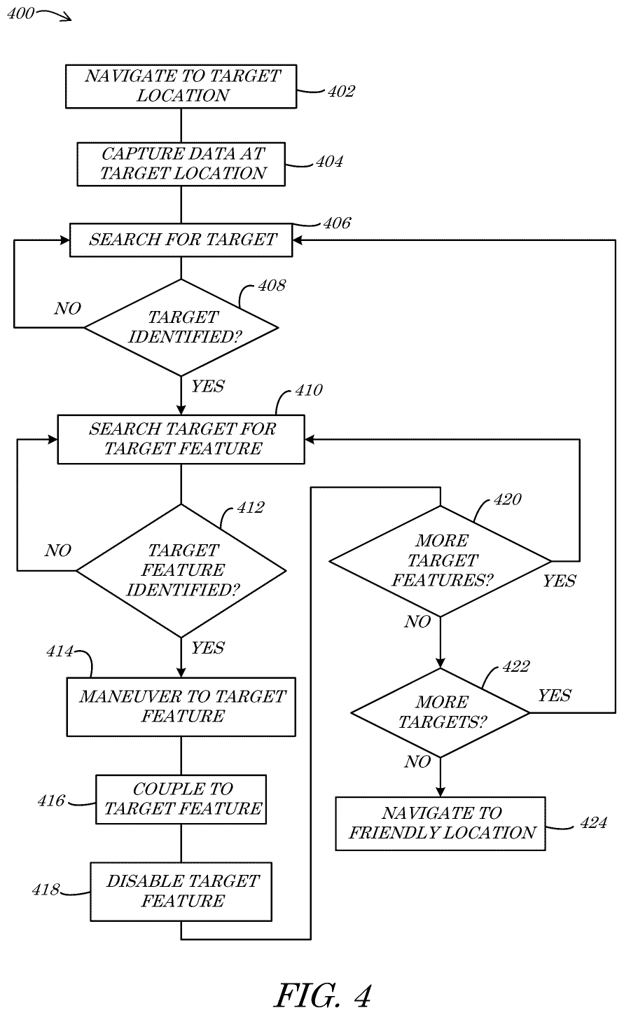

Fewer or more components 102, 102-1, 104, 110, 112, 114, 116, 118, 130, 132, 134, 140, 150 and/or various configurations of the depicted components 102, 102-1, 104, 110, 112, 114, 116, 118, 130, 132, 134, 140, 150 may be included in the system 100 without deviating from the scope of embodiments described herein. In some embodiments, the components 102, 102-1, 104, 110, 112, 114, 116, 118, 130, 132, 134, 140, 150 may be similar in configuration and/or functionality to similarly named and/or numbered components as described herein. In some embodiments, the system 100 (and/or portion thereof) may comprise a targeted operational disablement system and/or platform programmed and/or otherwise configured to execute, conduct, and/or facilitate the method 400 of FIG. 4 herein, and/or portions thereof.

According to some embodiments, the target 102 may comprise any type, configuration, and/or quantity of target vehicles, buildings, devices, and/or other objects that are or become known or desirable. The target 102 may comprise, for example, one or more military vehicles such as trucks, Armored Personnel Carrier (APC) vehicles, Infantry Fighting Vehicles (IFVs), MBT vehicles, artillery pieces (e.g., howitzers or Multiple Launch Rocket System (MLRS) vehicles—towed or self-propelled), etc. In some embodiments, the target feature 102-1 may comprise one or more predefined areas, portions, and/or objects of the target 102. In the case that the target 102 comprises a military vehicle, for example, the target feature 102-1 may comprise a main gun barrel, an access hatch, an engine (e.g., exhaust port or area), a wheel or tread, and/or a fuel tank. According to some embodiments, the target feature 102-1 may comprise a specific type of military equipment coupled to the target 102 such as a munition, a radar or other sensing and/or communications apparatus (e.g., a transmission and/or receiver antenna, array, dish, etc.), and/or a counter-measures device (e.g., an APS sensor and/or launcher). In some embodiments, the target feature 102-1 may comprise a feature with distinguishing geometry that permits for increased accuracy of identification such as the main gun barrel of an MBT or artillery piece, which has a distinct elongated geometry.

The network 104 may, according to some embodiments, comprise a Local Area Network (LAN; wireless and/or wired), cellular telephone, Bluetooth®, Near Field Communication (NFC), and/or Radio Frequency (RF) network with communication links between the controller device 110 and the unmanned vehicle 110. In some embodiments, the network 104 may comprise direct communication links between any or all of the components 110, 112, 114, 116, 118,130, 132, 134, 140, 150 of the system 100. The sensor 116 may, for example, be directly interfaced or connected to one or more of the processing device 112 and/or the remote server 130 via one or more wires, cables, wireless links, and/or other network components, such network components (e.g., communication links) comprising portions of the network 104. In some embodiments, the network 104 may comprise one or many other links or network components other than those depicted in FIG. 1. The unmanned vehicle 110 may, for example, be connected to the remote server 130 via various cell towers, routers, repeaters, ports, switches, cables (e.g., field telephone and/or guided-wire cables), and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 110, 112, 114, 116, 118, 130, 132, 134, 140, 150 of the system 100. The network 104 may comprise one or more cellular telephone networks with communication links between the communication device 114 and the remote server 130, for example, and/or may comprise an NFC or other short-range wireless communication path, with communication links between the coupling device 150 and the disabling device 118, for example (e.g., contact and/or engagement of the coupling device 150 with the target feature 102-1 may trigger the disabling device 118).

According to some embodiments, the unmanned vehicle 110 may comprise any type, configuration, and/or quantity of unmanned apparatus that is operable to maneuver to, identify, and/or disable the target feature 102-1. The unmanned vehicle 110 may comprise, for example, a Carrier™ Hx8 aerial payload-carrying drone available from Harris Aerial of Casselberry, FL, a Pegasus™ II or III transformable drone available from Robotic Research OpCp, LLC of Clarksburg, MD, and/or an autonomous, semi-autonomous, or RC ground vehicle. In some embodiments, the unmanned vehicle 110 may comprising the processing device 112 such as a Central Processing Unit (CPU) that executes instructions (not shown) stored in the memory device 140 to operate in accordance with embodiments described herein. The processing device 112 may, for example, execute one or more programs, modules, and/or routines that facilitate the targeted operational disablement of an identified target feature, as described herein. According to some embodiments, the processing device 112 may execute stored instructions, logic, and/or software modules to cause the unmanned vehicle 110 to (i) navigate to a location, (ii) search for and/or identify a target (e.g., the target 102), (iii) search for and/or identify a particular feature of the target (e.g., a tank main gun barrel, a tank tread, engine compartment, fuel tank, munition, magazine, hatch, launch tube, etc.; e.g., the target feature 102-1), (iv) maneuver to engage a coupling device with the target feature, and (v) activate a disablement device (e.g., shaped charge, thermite, etc.). The processing device 112 may comprise, in some embodiments, one or more Eight-Core Intel® Xeon® 7500 Series electronic processing devices.

According to some embodiments, the communication device 114 may comprise any wired and/or wireless communication object and/or network device such as, but not limited to, a Radio Frequency (RF) antenna, transmitter, and/or receiver. In some embodiments, the communication device 114 may comprise hardware, software, and/or firmware operable to enable wireless communications including, but not limited to, encoding and/or decoding modules, filters, and/or encryption and/or decryption modules. In some embodiments, the sensor 116 may comprise may any type, configuration, and/or quantity of sensor devices that are or become known or practicable. In some embodiments, the sensor 116 may comprise a Light Detection and Ranging (LiDAR), LAser Detection and Ranging (LADAR), radar, sonar, Infrared Radiation (IR), RF, structured light, and/or imaging device operable to acquire data descriptive of the unmanned vehicle 110 (e.g., a location, speed, pose, etc.), the target 102 and/or the target feature 102-1 thereof. According to some embodiments, the sensor 116 may also or alternatively comprise an accelerometer, gyroscope, locational positioning device, image, audio, and/or video capture and/or recording device, chemical detection device, and/or a light sensor. According to some embodiments, the sensor 116 may comprise various movement and/or navigational sensors such as speed/velocity sensors, pressure sensors, temperature sensors, locational positioning devices, and/or tilt sensors. In some embodiments, as described herein, the sensor 116 may be utilized to navigate to a location (e.g., a location proximate to the target 102), identify the target 102, identify the target feature 102-1, and/or to maneuver to engage/couple with the target feature 102-1. According to some embodiments, the sequence of these actions may be conducted automatically and/or autonomously.

In some embodiments, the disabling device 118 may comprise any type, configuration, and/or quantity of devices configured to damage or otherwise disable the target feature 102-1 (and/or the target 102). The disabling device 118 may comprise a shaped charge, for example, that is configured to delivery an explosive force in a particular direction, concentration, and/or manner to disable the target feature 102-1. According to some embodiments, the disabling device 118 may comprise a plurality of different explosive, corrosive, cutting, and/or obstruction devices (e.g., that may be selectively chosen by the unmanned vehicle 110 based on characteristics of the target 102 and/or target feature 102-1). The disabling device 118 may comprise, for example, a shaped charge designed to explosively create a hole into and/or through the target feature 102-1 and a damaging fluid substance (e.g., thermite, liquid nitrogen) coupled to pour through the hole and into the target feature 102-1. In some embodiments, the remote server 130 may comprise an electronic and/or computerized controller device, such as a computer server and/or server cluster communicatively coupled to interface with the unmanned vehicle 110 (directly and/or indirectly). The remote server 130 may, for example, comprise one or more PowerEdge™ M910 blade servers manufactured by Dell®, Inc. of Round Rock, TX, which may include one or more Eight-Core Intel® Xeon® 7500 Series electronic processing devices. According to some embodiments, the remote server 130 may be located remotely from one or more of the unmanned vehicle 110 and the target 102. The remote server 130 may also or alternatively comprise a plurality of electronic processing devices and/or remote and/or tele-operation stations located at one or more various sites and/or locations (e.g., a distributed computing and/or processing network).

According to some embodiments, the propulsion device 132 may comprise any type, configuration, and/or quantity of propulsion devices that are operable to move the unmanned vehicle 110 from one location to another. The propulsion device 132 may comprise, for example, one or more motors, engines, gears, drives, propellers, fans, jets, nozzles, wheels, treads, and/or magnetic propulsion devices. In some embodiments, such as in the case that the unmanned vehicle 110 comprises a quad-copter drone, the propulsion device 132 may comprise four (4) cooperatively coupled electric motors and propellers and/or associated gears, belts, chains, and/or cables. According to some embodiments, the power device 134 may be electrically coupled to provide power to any or all of the propulsion device(s) 132, the communication device 114, the processing device 112, the sensor 116, the disabling device 118, and/or the coupling device 150. In some embodiments, the power device 134 may comprise a power source such as a solar panel, generator, on-board generator, fuel-cell, external power supply port, etc. According to some embodiments, the power device 134 may also or alternatively comprise a power storage device such as one or more capacitors, batteries, fuel reservoirs or tanks, etc.

In some embodiments, the memory device 140 may store various logic, code, and/or applications, each of which may, when executed, participate in, facilitate, and/or cause targeted operational disablement, as described herein. In some embodiments, the memory device 140 may comprise any type, configuration, and/or quantity of data storage devices that are or become known or practicable. The memory device 140 may, for example, comprise an array of optical and/or solid-state memory cards or hard drives configured to store sensor data, object classification data, navigation data, routing and/or maneuvering data (e.g., analysis formulas and/or mathematical models), credentialing and/or communication instructions, codes, and/or keys, and/or various operating instructions, drivers, etc. In some embodiments, the memory device 140 may comprise a solid-state and/or non-volatile memory card (e.g., a Secure Digital (SD) card, such as an SD Standard-Capacity (SDSC), an SD High-Capacity (SDHC), and/or an SD eXtended-Capacity (SDXC) and any various practicable form-factors, such as original, mini, and micro sizes, such as are available from Western Digital Corporation of San Jose, CA. While the memory device 140 is depicted as a stand-alone component of the unmanned vehicle 110, the memory device 140 may comprise multiple components. In some embodiments, a multi-component memory device 140 may be distributed across various devices and/or may comprise remotely dispersed components. Either of the unmanned vehicle 110 and/or the remote server 110 may comprise the memory device 140 or a portion thereof, for example.

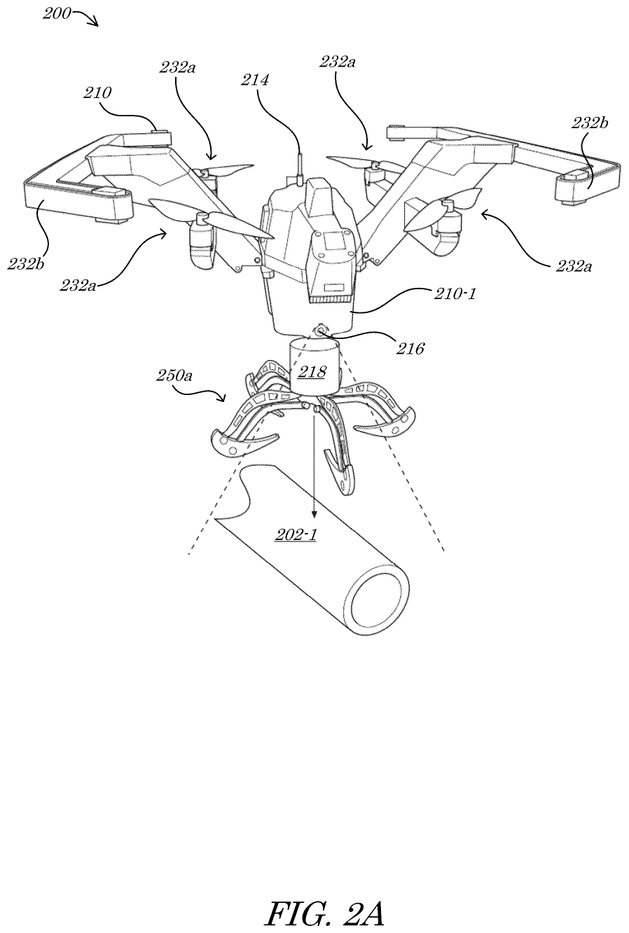

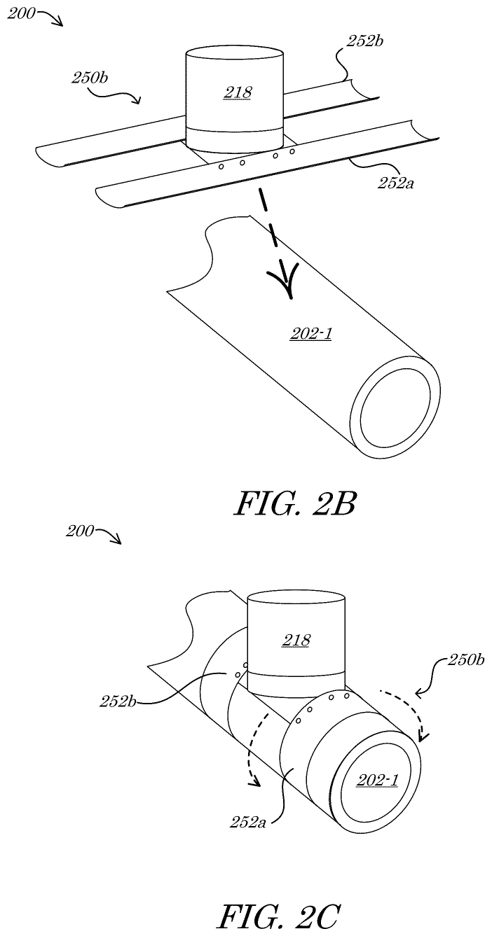

Turning to FIG. 2A, FIG. 2B, FIG. 2C, FIG. 2D, and FIG. 2E, perspective diagrams of a system 200 according to some embodiments are shown. In some embodiments, the system 200 may comprise a system that enables, facilitates, and/or conducts or effectuates targeted operational disablement. The system 200 may comprise, for example, a target feature 202-1 that is tactically engaged by a specially-outfitted and/or programmed drone 210. The drone 210 may comprise, for example, a housing and/or body 210-1 that is coupled to a communication device 214, a sensor 216, and/or a disabling device 218. In some embodiments, the drone 210 may comprise one or more propulsion devices 232a-b and/or one or more coupling devices 250a-c. As depicted in FIG. 2A, in a non-limiting case where the drone 210 comprises a transformable unmanned vehicle such as the depicted Pegasus™ III transformable drone available from Robotic Research OpCp, LLC of Clarksburg, MD, the propulsion devices 232a-b may comprise one or more first propulsion devices 232a such as plurality (e.g., four (4)) of electric motors and rotors, as well as second propulsion devices 232b such as selectively engageable ground treads (which may, e.g., be driven by motors (not shown) separate from those that power the first propulsion devices 232a).

According to some embodiments, such as depicted in FIG. 2A, a first coupling device 250a may comprise a claw or grabber that is operable to be engaged with the target feature 202-1. As depicted for non-limiting purposes of example, the target feature 202-1 is depicted as a portion of a tube-like structure such as may be representative of a large-caliber gun or cannon barrel (although no rifling is shown for ease of illustration). In some embodiments, the drone 210 may utilize the sensor 216 to identify and/or locate the target feature 202-1 and to automatically control the first propulsion devices 232a (and/or the second propulsion devices 232b) to maneuver the drone 210 to position the first coupling device 250a over and/or on the target feature 202-1. As directed by data received from the sensor 216 and/or based on contact and/or engagement of the first coupling device 250a with the target feature 202-1 (e.g., based on mechanical, analog, and/or digital readings provided by the first coupling device 250a), in some embodiments, the first coupling device 250a may automatically engage with the target feature 202-1 to mate and/or couple thereto. In the case of the first coupling device 250a being a claw mechanism as shown in FIG. 2A, for example, once the first coupling device 250a is determined to be in position the first coupling device 250a may be activated to close the claw and grasp the target feature 202-1.

In some embodiments, the coupling of the coupling devices 250a-c to the target feature 202-1 may be either selectively reversible (e.g., the first coupling device 250a claw may be opened to release the target feature 202-1) or permanent (e.g., the coupling devices 250a-c may fixedly mount to the target feature 202-1 such as by utilizing material fusion, adhesives, and/or mechanical attachment). In either case, the coupling devices 250a-c may be selectively detached and/or deployable from the drone 210. Particularly in the case of permanent attachment of the coupling devices 250a-c to the target feature 202-1, for example, the drone 210 may engage the coupling devices 250a-c with the target feature 202-1 to cause the permanent attachment, disengage and/or decouple from the coupling devices 250a-c and maneuver away from the target feature 202-1, leaving the coupling devices 250a-c attached thereto.

According to some embodiments, the disabling device 218 may be coupled to and/or integrated with the coupling devices 250a-c. The disabling device 218 and the coupling devices 250a-c may, for example, comprise a deployable payload of the drone 210. In some embodiments, the disabling device 218 may be coupled to and/or integrated with the drone 210. The coupling devices 250a-c may, for example, position the disabling device 218 with respect to the target feature 202-1 (e.g., in accordance with predetermined positioning or targeting parameters) but may not be coupled to the disabling device 218. In some embodiments, once the disabling device 218 is positioned adjacent to, on, and/or in the target feature 202-1, the drone 210 may activate the disabling device 218 to disable the target feature 202-1. In the case that the target feature 202-1 comprises a gun/cannon barrel, for example, the disabling device 218 may activate a shaped charge that punches a hole and/or cuts one or more slits (axial and/or lateral) into the barrel. In the case of a large caliber primary weapon barrel such as a man gun barrel of an MBT vehicle, even a single hole in the barrel may be enough of a disablement to reduce or entirely prevent the operational usage of the main gun barrel. Rounds fired from a barrel acted upon by the disabling device 218 may, for example, suffer a significant loss in accuracy and/or may cause adverse pressure effects that further damage or destroy the barrel. According to some embodiments, the disabling device 218 may comprise a shaped charge of approximately one pound (1-lb.) or less that, e.g., is operable to form a hole of approximately one inch (1″) in diameter or larger in the target feature 202-1.

In some embodiments, different types of coupling devices 250a-c and/or disabling devices 218 may be utilized by the drone 210. With reference to FIG. 2B and FIG. 2C, for example, a second coupling device 250b may comprise one or more bistable spring bands 252a-b that are configured to automatically couple to the target feature 202-1 upon physical engagement therewith. The bands 252a-b may, in some embodiments, comprise elongated metal strips comprising and/or defining convex cross-sections that, upon application of a force (e.g., a contact force) to the convex cross section, causes the bands 252a-b to mechanically transition from a first or elongated state as depicted in FIG. 2B to a second, wrapped, and/or engaged state as depicted in FIG. 2C.

According to some embodiments, the second coupling device 250b may comprise any number and/or type of bistable structures that are or become known or practicable. Such structures may include, but are not limited to, mechanical (e.g., the bistable spring bands 252a-b), electro-magnetic, and/or thermal bistable structures.

According to some embodiments, and with reference to FIG. 2D and FIG. 2E, a third coupling device 250c may comprise a magnetic (and/or electromagnetic) fitting configured to magnetically couple to the target feature 202-1. The third coupling device 250c may comprise, for example, an arrangement of one or more permanent (e.g., rare earth or Neodymium Iron Boron (NdFeB) magnets, Samarium Cobalt (SmCo) magnets, Alnico magnets, and/or Ceramic or Ferrite magnets), temporary, and/or electromagnets configured to mate with target surfaces of various geometries. The semi-cylindrical shape of the third coupling device 250c depicted for non-limiting purposes of example in FIG. 2D and FIG. 2E may, for example, be sized and/or shaped to fit over a barrel of a particular caliber (or range of calibers). In some embodiments, such as in the case that a desired target feature 202-1 comprise a hatch, compartment, and/or other flat-surfaced area, the third coupling device 250c may comprise a planar arrangement (not shown) of magnets. In some embodiments, such as in the case that one or more electromagnets are utilized in the third coupling device 250c, the third coupling device 250c may be selectively activated to magnetize and couple to the target feature 202-1, e.g., once it is determined that the third coupling device 250c is properly positioned adjacent to, over, in and/or on the target feature 202-1.

While the target feature 202-1 is depicted in each of FIG. 2A, FIG. 2B, FIG. 2C, FIG. 2D, and FIG. 2E as a tube or barrel, the target feature 202-1 may comprise one or more varying geometries dependent upon the type of feature desired for targeting. Similarly, while the disabling device 218 is depicted as a simple cylinder for ease of explanation, the disabling device 218 may comprise any number, shape, and/or size of disabling mechanisms, devices, and/or objects that are capable of disabling the target feature 202-1. Further, while the second coupling device 250b and the third coupling device 250c are shown as being coupled to the respective disabling device 218 in the absence of the drone 210, this is predominantly for ease of illustration. In some embodiments, for example, the second coupling device 250b and the third coupling device 250c may be coupled to the drone 210 while advancing to couple to the target feature 202-1 and/or while coupled to the target feature 202-1. According to some embodiments however, the second coupling device 250b and the third coupling device 250c and the respective disabling device 218 may have been deposited and/or placed by the drone 210 that then departed from the target feature 202-1. The drone 210 may comprise a re-usable device operable to selectively deploy the disabling device 218 and/or to activate the disabling device 218 in a manner that is not likely to damage the drone 210, for example, or may comprise a sacrificial device that is not operable to disengage from the target feature 202-1 and/or that is designed to be consumed upon engagement with the target feature 202-1.

Fewer or more components 202-1, 210, 214, 216, 218, 232a-b, 250a-c and/or various configurations of the depicted components 202-1, 210, 214, 216, 218, 232a-b, 250a-c may be included in the system 200 without deviating from the scope of embodiments described herein. In some embodiments, the components 202-1, 210, 214, 216, 218, 232a-b, 250a-c may be similar in configuration and/or functionality to similarly named and/or numbered components as described herein. In some embodiments, the system 200 (and/or portion thereof) may comprise a targeted operational disablement system and/or platform programmed and/or otherwise configured to execute, conduct, and/or facilitate the method 400 of FIG. 4 herein, and/or portions thereof.

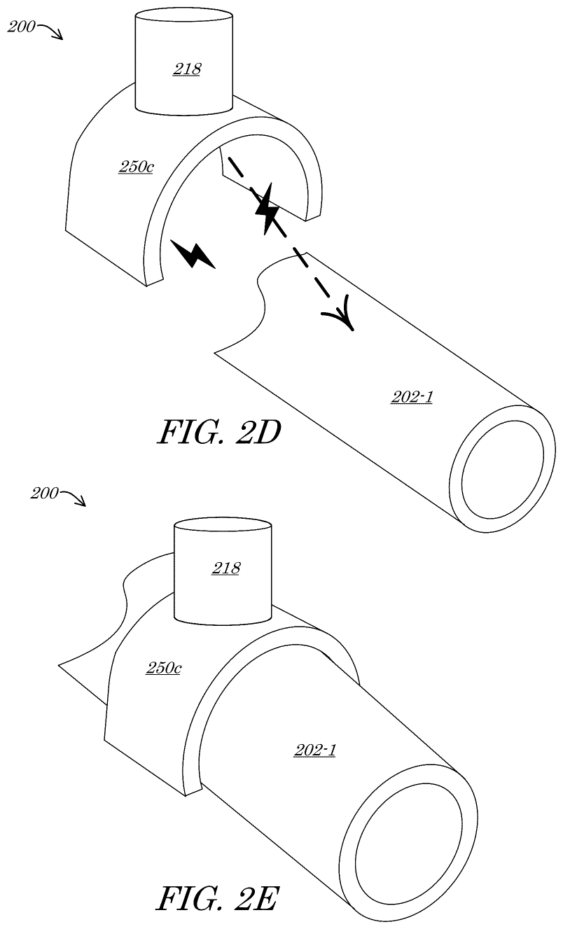

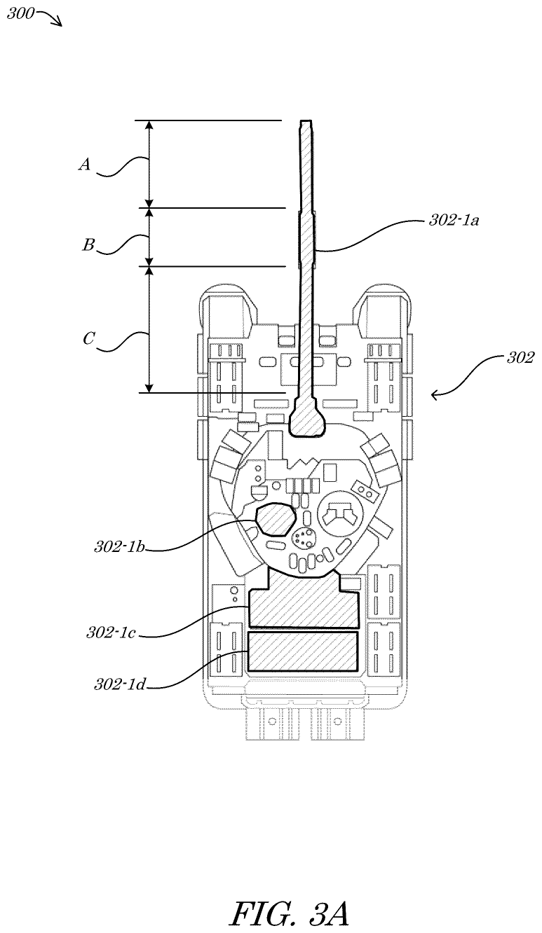

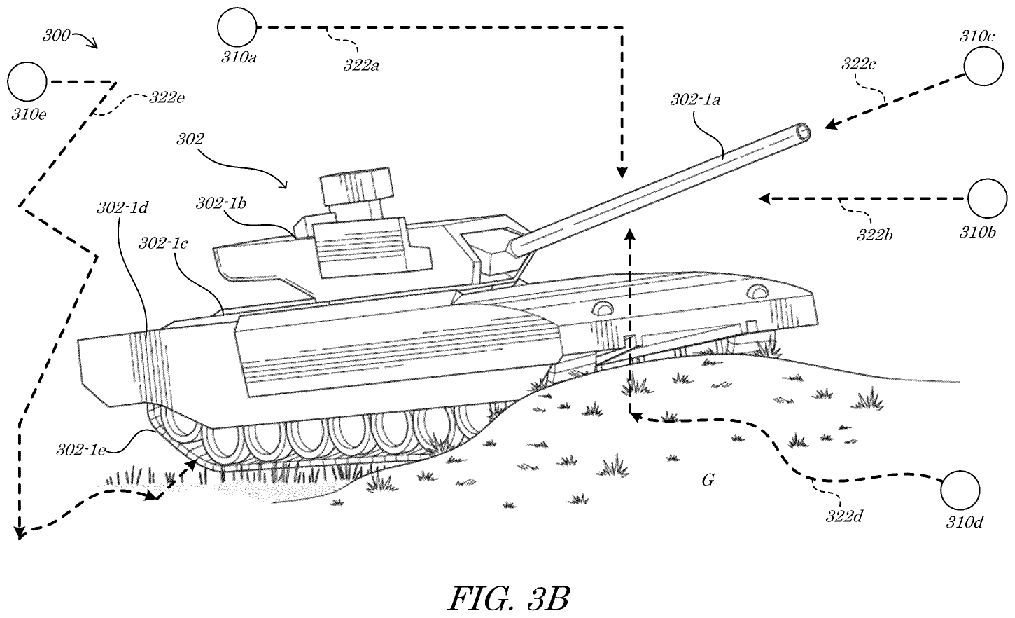

Turning now to FIG. 3A and FIG. 3B, plan and perspective views, respectively, of a system 300 according to some embodiments are shown. In some embodiments, as depicted in FIG. 3A, the plan view may comprise an overhead or top-down representation of an MBT vehicle 302 while the perspective view in FIG. 3B may show the vehicle 302 in partial “hull down” or in defilade position behind an earthen crest or ground feature “G”. While the vehicle 302 is depicted as an MBT for purposes of non-limiting example, in some embodiments the vehicle 302 may also or alternatively comprise one or more other target vehicles, buildings, and/or objects. In some embodiments, the vehicle 302 may comprise and/or define various target features 302-1a, 302-1b, 302-1c, 302-1d, 302-1e. In the case of the MBT vehicle 302, for example, a first target feature 302-1a may comprise a main gun barrel, a second target feature 302-1b may comprise a crew hatch, a third target feature 302-1c may comprise a magazine and/or munition storage area, a fourth target feature 302-1d may comprise an engine, engine compartment, engine access panel, and/or engine exhaust port or area, and/or a fifth target feature 302-1e may comprise a tread, wheel, and/or other mobility and/or propulsion device.

In some embodiments, various attributes of the target features 302-1a, 302-1b, 302-1c, 302-1d, 302-1e may be stored in a memory or database (not shown; e.g., the memory device 140 of FIG. 1 herein). According to some embodiments, a targeted operational disablement system such as one or more drones 310a-e (not shown in detail, but depicted as a simple circles for ease of reference in FIG. 3B; e.g., the unmanned vehicle 110 of FIG. 1 and/or the drone 210 of FIG. 2A, FIG. 2B, FIG. 2C, FIG. 2D, and FIG. 2E herein) may compare (and/or otherwise analyze, e.g., utilizing object recognition) the stored data to data acquired at a target location (e.g., a location of the vehicle 302) to identify one or more of the target features 302-1a, 302-1b, 302-1c, 302-1d, 302-1e. The plan view of the system 300 in FIG. 3A may represent, for example, a simplified sensor readout, image, and/or map as-viewed by an overhead targeted operational disablement system and/or drone 310a-e. According to some embodiments, the target features 302-1a, 302-1b, 302-1c, 302-1d, 302-1e may be specifically selected and/or defined based on their operational importance/value to the vehicle 302 and/or based on a quantified degree of recognizability. Various geometric (e.g., size, length width, caliber/bore, angle), thermal, magnetic field, and/or other attribute data may be analyzed, for example, to select target features 302-1a, 302-1b, 302-1c, 302-1d, 302-1e that have a high degree of probability of being recognized by available sensor and sensor data processing technologies. The target features 302-1a, 302-1b, 302-1c, 302-1d, 302-1e may, for example, be identified (e.g., by execution of image analysis, Artificial Intelligence (AI), and/or Machine Learning ML) algorithms), categorized, separately scored, weighted, ranked, and/or prioritized. In the case of the second target feature 302-1b, for example, the relatively distinctive round shape of the crew hatch may score highly with respect to likelihood of in-field identification due to the simple geometry thereof. In the case of the first target feature 302-1a, the distinctive elongated geometry (e.g., high aspect ratio: length divided by bore/diameter of between thirty-five (35) and sixty (60); in some embodiments, an aspect ratio of approximately forty-eight (48)) of the main gun and/or the in-operation heat signature of the main gun may be utilized to score the first target feature 302-1a highly (or highest) with respect to likely identifiability. According to some embodiments, multiple different sensor readings may be compared to derive a confidence level. In the case that image analysis identifies the first target feature 302-1a main gun due to the high aspect ratio geometry, for example, a partial score indicating the importance of a main gun may be either bolstered by a heat signature and/or magnetic reading that indicates that the first target feature 302-1a is made of metal or decreased by a heat signature and/or magnetic reading that indicates that the first target feature 302-1a is made of wood (e.g., a downed tree, telephone pole, etc.). In some embodiments, while either of the third target feature 302-1c and the fourth target feature 302-1d may score lower due to their more generic rectangular geometries, their scores may be increased due to the potential effectiveness of disablement of the vehicle 302 if such areas were successfully engaged (e.g., detonation and/or immobilization). In some embodiments, while the fifth target feature 302-1e may be easily identified (e.g., with a high mathematical image analysis confidence level) due to the many interoperable and/or connected continuous track segments, drive wheels, idler wheels, rollers, gears, and/or other components (not separately labeled), it may be scored the lowest out of all identified features due to the likelihood that a successful disablement procedure is only likely to temporarily immobilize the vehicle 310. MBT crews and support vehicles and personnel are typically well-equipped to remediate a track issue, for example, while they are unlikely as well prepared to remediate an inoperable main gun—e.g., in the cases in which the vehicle 310 is damaged as opposed to destroyed.

According to some embodiments, one or more specific areas, portions, or sub-features of a target feature 302-1a, 302-1b, 302-1c, 302-1d, 302-1e may be identified and/or selected. In the case of the first target feature 302-1a, and as depicted in FIG. 3A for example, first (“A”), second (“B”), and/or third (“C”) portions of the gun barrel may be identified. The different portions “A”, “B”, “C” may, for example, be separately scored, weighted, ranked, and/or prioritized based on various different characteristics thereof. It may be determined, for example, that the third portion “C” of the first target feature 302-1a is the most desirable feature (and/or warrants a first score or rank) because causing a breach in the barrel close to the detonation of the propellant for a round is likely to cause the largest pressure differential which is accordingly likely to cause the most follow-on damage in the case that the barrel is utilized after disablement. In some embodiments, the first portion “A” of the first target feature 302-1a may be determined to warrant a second score or rank due to the decreased likelihood that countermeasures will be able to detect and/or engage with a targeted operational disablement system operating at such a distal end of the barrel. In some embodiments, the various weights, scores, ranks, and/or other metrics derived, computed, and/or calculated for the different target features 302-1a, 302-1b, 302-1c, 302-1d, 302-1e and/or different portions “A”, “B”, “C” thereof may be utilized to selectively choose which different target features 302-1a, 302-1b, 302-1c, 302-1d, 302-1e and/or different portions “A”, “B”, “C” thereof should be (i) actively identified, (ii) targeted, and/or (iii) engaged for disablement.

In some embodiments, the drone(s) 310a-e may actively, automatically, and/or autonomously derive, compute, plot, and/or select or choose one or more attack paths 322a-e via which the vehicle 302 may be approached and/or engaged for disablement. As shown in FIG. 3B, for example, a first drone 310a may plot and/or travel along a first path 322a in which the first drone 310a flies horizontally (generally) above the vehicle 302 and then descends vertically down to engage with the first target feature 302-1a. According to some embodiments, the first drone 310a may execute a (first) navigational algorithm in which the first path 322a from a current position of the first drone 310a to the first target feature 302-1a is computed. The first path 322a may include, for example, a plurality of specified coordinates (and/or other geo-location metrics), distances, speeds, altitudes/elevations, bearings, headings, and/or angles, rates of decent/ascent, etc., defining the first path 322a. In some embodiments, the first path 322a may comprise a simple flight path that relocates the first drone 310a over the first target feature 302-1a and then directs the first drone 310a directly to the first target feature 302-1a.

According to some embodiments, a second drone 310b may plot and/or travel along a second path 322b in which the second drone 310b flies horizontally (generally) directly toward the vehicle 302, e.g., to engage with the first target feature 302-1a from a proximate altitude of the first target feature 302-1a. According to some embodiments, the second drone 310b may execute a (second) navigational algorithm in which the second path 322b from a current position of the second drone 310b to the first target feature 302-1a is computed. The second path 322b may include, for example, a plurality of specified coordinates (and/or other geo-location metrics), distances, speeds, altitudes/elevations, bearings, headings, and/or angles, rates of decent/ascent, etc., defining the second path 322b. In some embodiments, the second path 322b may comprise a safer (e.g., less likely to result in loss of the second drone 310b) flight path that engages the second drone 310b horizontally with the first target feature 302-1a from the front of the vehicle 302. An APS of the vehicle 310 may, for example, not be focused on or offer as robust protection for the front of the vehicle 310a where the armor thereof is typically the thickest. Small threats, like the second drone 310b from the front and/or from a low altitude may be perceived as personnel-deployed, direct-fire anti-tank weapons such as RPG devices, for example, that are generally not effective on the front armor, and such threats may accordingly be ignored. The second drone 310b may exploit such a weakness by selecting the second path 322b. In some embodiments, the second path 322b may be based upon and/or selected at least in part based on the identification of the vehicle 302 (and/or the first target feature 302-1a). The second drone 310b may, for example, identify the likely make, model, serial number, country-of-origin, configuration, and/or other characteristic of the vehicle 302, e.g., based on sensor readings and/or third-part data (e.g., a remote identification determination sent to the second drone 310b). In some embodiments, capability information for the identified and/or categorized vehicle 302 may be utilized to identify the second path 322b as a tactical path that ranks the highest amongst a plurality of possible paths based on the capabilities of the vehicle 302.

In some embodiments, a third drone 310c may plot and/or travel along a third path 322c in which the third drone 310c flies directly toward the first target feature 302-1a along an axis of the main gun barrel. According to some embodiments, the third drone 310c may execute a (third) navigational algorithm in which the third path 322c from a current position of the third drone 310c to the first target feature 302-1a is computed. The third path 322c may include, for example, a plurality of specified coordinates (and/or other geo-location metrics), distances, speeds, altitudes/elevations, bearings, headings, and/or angles, rates of decent/ascent, etc., defining the third path 322c. In some embodiments, the third path 322c may comprise a specialized flight path that is selected and/or defined to engage the third drone 310c with the bore of the first target feature 302-1a. The third drone 310c may comprise and/or carry, for example, a disabling device (not shown) designed to be engaged with and/or within the bore of the first target feature 302-1a, and the third path 322c may be selected to align the disabling device and/or third drone 310c with the bore for engagement therewith.

According to some embodiments, a fourth drone 310d may plot and/or travel along a fourth path 322d in which the fourth drone 310d (e.g., a transformable and/or multi-locomotion drone) drives along the ground surface of the ground feature “G” toward the vehicle 302 (and/or the first target feature 302-1a) and then flies/launches upward to engage with the first target feature 302-1a from below. According to some embodiments, the fourth drone 310d may execute a (fourth) navigational algorithm in which the fourth path 322d from a current position of the fourth drone 310d to the first target feature 302-1a is computed. The fourth path 322d may include, for example, a plurality of specified coordinates (and/or other geo-location metrics), distances, speeds, altitudes/elevations, bearings, headings, and/or angles, rates of decent/ascent, etc., defining the fourth path 322d.

In some embodiments, the fourth path 322d may be selected and/or defined based on known capabilities of the fourth drone 310d (such as multi-locomotion capabilities—e.g., ground movement and flight) and/or based on characteristics of the vehicle 302. In the case that the fourth drone 310d identifies the vehicle 302 as a type of vehicle that is likely to comprise an APS, for example, and in the case that the fourth drone 310d comprises the ability to drive along the ground and fly (or launch), the fourth path 322d may be chosen and/or defined. The fourth path 322d may, for example, utilize the ground feature “G” as an advantage to hide from the vehicle 302 as the fourth drone 310d approaches to within a proximity of (e.g., underneath) the first target feature 302-1a such that chances of detection are minimized. The fourth path 322d may then comprise a flight and/or launch portion in which the fourth drone 310d engages the first target feature 302-1a from below—which may comprise a direction of attack for which the vehicle 302 was not designed and/or for which the vehicle 302 does not have an adequate defense.

In some embodiments, a fifth drone 310e may plot and/or travel along a fifth path 322e in which the fifth drone 310e (e.g., a transformable and/or multi-locomotion drone) executes and/or takes an evasive flight path to arrive proximate to the vehicle 302 and then drives along the ground surface toward the vehicle 302 (and/or the fifth target feature 302-1e) to engage with the fifth target feature 302-1e from the side (or rear). According to some embodiments, the fifth drone 310e may execute a (fifth) navigational algorithm in which the fifth path 322e from a current position of the fifth drone 310e to the fifth target feature 302-1e is computed. The fifth path 322e may include, for example, a plurality of specified coordinates (and/or other geo-location metrics), distances, speeds, altitudes/elevations, bearings, headings, and/or angles, rates of decent/ascent, etc., defining the fifth path 322e. In some embodiments, the fifth path 322e may be selected and/or defined as an evasive path designed to thwart, confuse, frustrate, and/or avoid detection and/or interception by the vehicle 302 (and/or by another defensive system; not shown). The fifth path 322e may comprise multiple “zig-zag” segments, for example, such that the likely ending point or target of the fifth drone 310e is not readily discernable by the vehicle 302 (and/or by other entities).

According to some embodiments, a plurality of the drones 310a-e (and/or fewer or additional drones that are not shown) may conduct a coordinated attack upon the vehicle 302. The various paths 322a-e may be selectively chosen and/or defined, for example, to coordinate attacks from multiple directions, in multiple manners, and/or against multiple different target features 302-1a, 302-1b, 302-1c, 302-1d, 302-1e simultaneously and/or at coordinate delayed times. The first drone 310a may execute an attack along the first path 322a at a first time to trigger the APS of the vehicle 302, for example, while one or more of the other drones 310b-e may have their arrival times at the vehicle 302 staggered to avoid impact from APS activation (e.g., several seconds after the arrival time of the first drone 310a). In some embodiments, one or more of the drones 310a-e may be directed specifically to disabling and/or frustrating the APS and/or another system of the vehicle 302 while one or more of the other drones 310a-e are specifically directed to engaging with and/or disabling a plurality of the target features 302-1a, 302-1b, 302-1c, 302-1d, 302-1e.

Fewer or more components 302, 302-1a, 302-1b, 302-1c, 302-1d, 302-1e, 310a-e and/or various configurations of the depicted components 302, 302-1a, 302-1b, 302-1c, 302-1d, 302-1e, 310a-e may be included in the system 300 without deviating from the scope of embodiments described herein. In some embodiments, the components 302, 302-1a, 302-1b, 302-1c, 302-1d, 302-1e, 310a-e may be similar in configuration and/or functionality to similarly named and/or numbered components as described herein. In some embodiments, the system 300 (and/or portion thereof) may comprise a targeted operational disablement system and/or platform programmed and/or otherwise configured to execute, conduct, and/or facilitate the method 400 of FIG. 4 herein, and/or portions thereof.

### III. Targeted Operational Disablement Methods

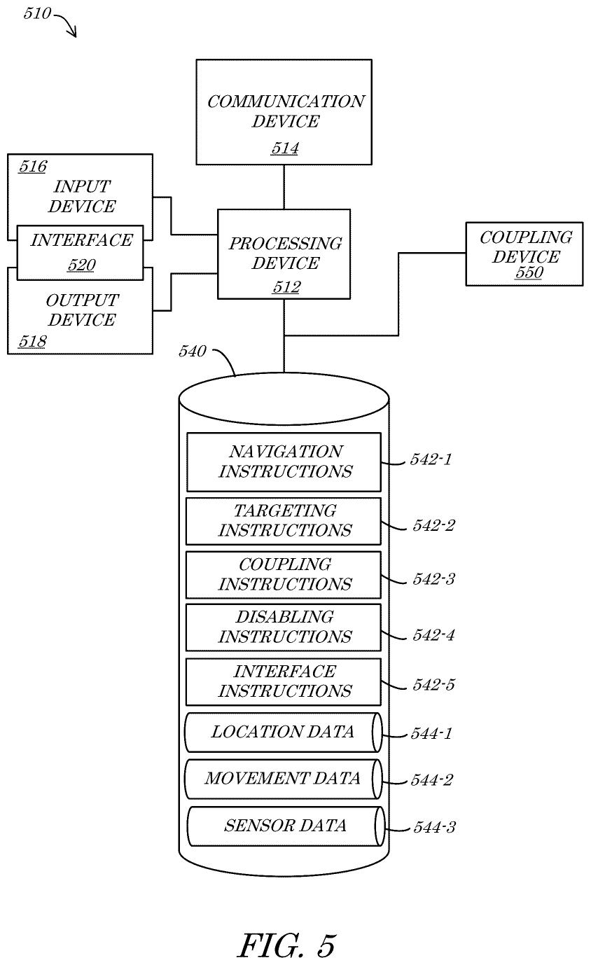

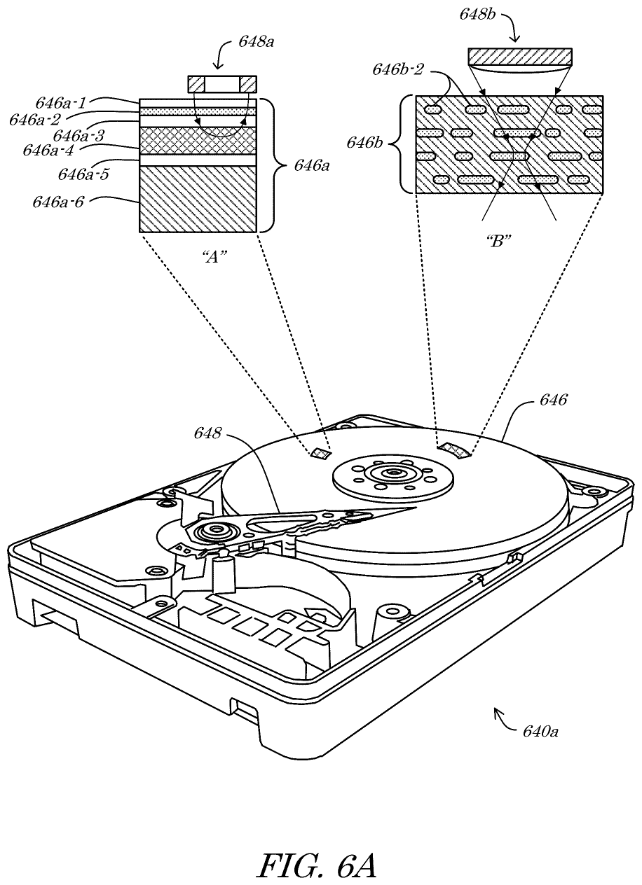

Referring now to FIG. 4, a flow diagram of a method 400 according to some embodiments is shown. In some embodiments, the method 400 may be performed and/or implemented by and/or otherwise associated with one or more specialized and/or specially-programmed computing devices (e.g., one or more of the unmanned vehicles 110, remote server 130, drones 210, 310a-e, and/or the apparatus 510 of FIG. 1, FIG. 2A, FIG. 2B, FIG. 2C, FIG. 2D, FIG. 2E, FIG. 3B, and/or FIG. 5 herein), computer terminals, computer servers, computer systems and/or networks, and/or any combinations thereof (e.g., by one or more multi-threaded and/or multi-core processing units of a targeted operational disablement processing system). In some embodiments, the method 400 may be embodied in, facilitated by, and/or otherwise associated with various input mechanisms and/or interfaces.

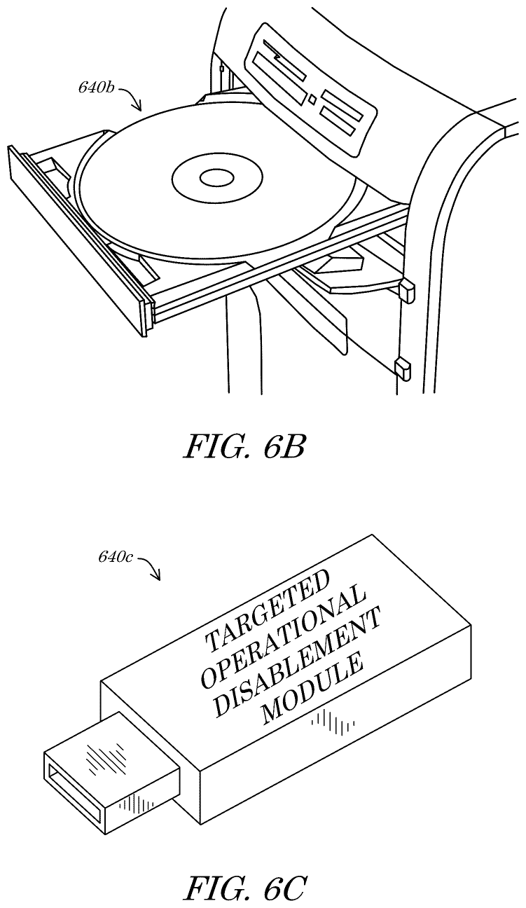

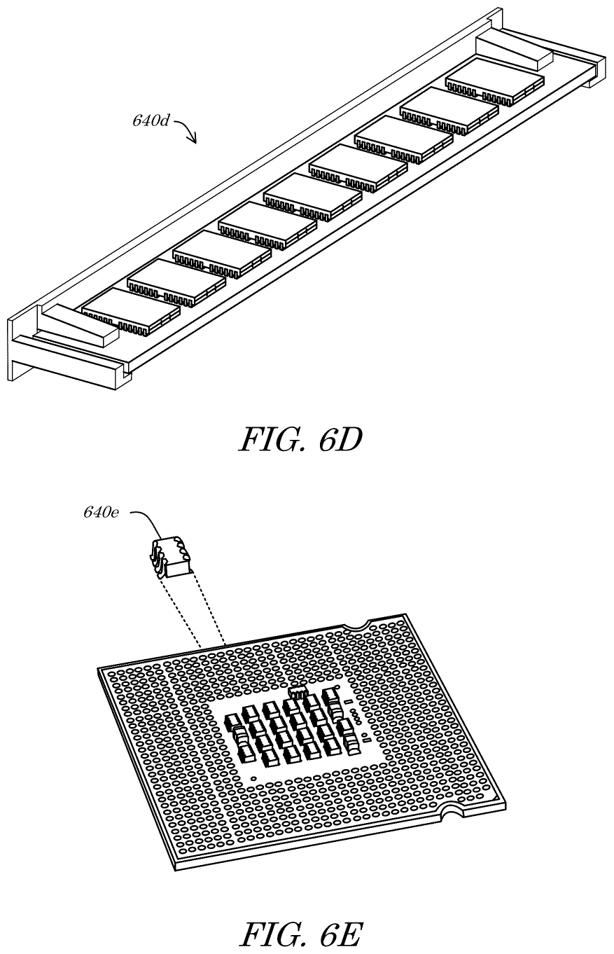

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory/data storage devices 140, 540, 640a-e of FIG. 1, FIG. 5, FIG. 6A, FIG. 6B, FIG. 6C, FIG. 6D, and/or FIG. 6E, herein) may store thereon instructions that when executed by a machine (such as a computerized processor) result in performance according to any one or more of the embodiments described herein.

In some embodiments, the method 400 may comprise navigating to a target location, at 402. An unmanned vehicle may, for example, utilize a navigational routing program, routine, and/or module to operate upon an input location identifier (e.g., coordinates) to plan a navigational routing from a starting location of the vehicle to the target location. The target location may comprise, for example, a location at or near which a target has been identified (e.g., by others) and/or may comprise a target designation indicator such as a laser, heat, and/or other signature and/or emission. According to some embodiments, the unmanned vehicle may traverse the navigational route by, e.g., selectively activating one or more propulsion and/or control surface or steering mechanisms.

According to some embodiments, the method 400 may comprise capturing data at the target location, at 404. The unmanned vehicle may utilize one or more sensors (e.g., LiDAR, imaging devices) to scan the target location and/or area, for example. According to some embodiments the sensor data may define a map, point cloud, surface model, and/or digital elevation model of the target area. In some embodiments, the method 400 may comprise searching for the target, at 406. The data acquired by the sensor may be analyzed, for example, by comparing identified data signatures (e.g., object geometries, thermal signatures, radar signatures, etc.) to stored target signatures to identify one or more targets represented within the acquired data set. According to some embodiments, the processing may comprise one or more object classification, analysis, and/or identification routines that operate upon the captured input data to generate a weighted map (e.g., a ‘heat’ map) representing likelihoods of areas (e.g., pixels and/or groups of proximate pixels) matching stored signatures/objects. In some embodiments, the method 400 may comprise determining whether a target has been identified, at 408. In the case that a match is identified between captured data and stored data signatures (e.g., one or more pixels and/or areas match stored data thresholds within a predefined likelihood parameter threshold), a target may be identified. According to some embodiments, the searching at 406 and/or the identifying of the target at 408 may be conducted by an AI and/or ML model that has been pre-trained with a data set defining a plurality of data signatures (e.g., object geometries, thermal signatures, radar signatures, etc.) of known and/or previous objects.

In some embodiments, in the case that no target is identified, the method 400 may loop back and/or proceed to searching for targets at 406. According to some embodiments, in the case that a target is identified, the method 400 may proceed to and/or comprise searching for a target feature, at 410. The data acquired by the sensor may be analyzed, for example (and/or additional data may be acquired, e.g., by re-scanning a portion of the target area that is indicative of the target), by comparing identified data signatures (e.g., object geometries, thermal signatures, radar signatures, etc.) to stored target feature signatures to identify one or more target features represented within the acquired data set. According to some embodiments, the processing may comprise one or more object classification, analysis, and/or identification routines that operate upon the captured input data to generate a weighted map (e.g., a ‘heat’ map) representing likelihoods of areas (e.g., pixels and/or groups of proximate pixels) matching stored signatures/objects. In some embodiments, the method 400 may comprise determining whether a target feature has been identified, at 412. In the case that a match is identified between captured data and stored data signatures (e.g., one or more pixels and/or areas match stored data thresholds within a predefined likelihood parameter threshold), a target feature may be identified. In some embodiments, the target feature analysis may be limited and/or focused to areas indicating the location of the target (and/or areas within a predefined range thereof). In some embodiments, the searching at 410 and/or the identifying of the target at 412 may be conducted by an AI and/or ML model that has been pre-trained with a data set defining a plurality of data signatures (e.g., object geometries, thermal signatures, radar signatures, etc.) of known and/or previous objects.

According to some embodiments, in the case that no target feature is identified, the method 400 may loop back and/or proceed to searching for target features at 410. According to some embodiments, in the case that a target feature is identified, the method 400 may proceed to and/or comprise maneuvering to the target feature, at 414. In some embodiments, such as in the case that multiple targets and/or target features are identified, a targeting algorithm may be executed to automatically choose, rank, and/or prioritize the identified targets and/or target features. According to some embodiments, the unmanned vehicle may selectively activate propulsion and/or control/steering mechanisms to maneuver to the selected (e.g., highest ranked and/or prioritized) target feature. According to some embodiments, one or more paths from a plurality of available paths and/or tactical attack options/methodologies may be automatically and/or autonomously chosen, e.g., based on characteristics of the target, terrain, theatre of operations, rules of engagement, etc.

In some embodiments, the method 400 may comprise coupling to the target feature, at 416. In response to a determination that the unmanned vehicle is positioned within an acceptable threshold distance, orientation, angle, and/or location with respect to the target feature, for example, a coupling mechanism of the unmanned vehicle may be activated. In cases where the unmanned vehicle comprises multiple coupling mechanisms (e.g., of different types), one of the coupling mechanisms may be selected for activation, e.g., based on the target feature, target, environmental factors, mission goals, etc. In some embodiments, activation of the coupling mechanism may comprise closing a claw or clamping mechanism, energizing an electromagnet, actuating a servo and/or other mechanical and/or electro-mechanical actuation, and/or opening a valve or container, e.g., depending upon the configuration of the particular coupling device employed.

According to some embodiments, the method may comprise disabling the target feature, at 418. Once the coupling has occurred, for example, a disabling device such as an explosive, saw, torch, drill, and/or other disabling mechanism may be activated to engage with and damage the target feature. In some embodiments, the disabling mechanism may be positioned at a predefined distance (and/or within a predefined target range) from the target feature and/or a particular surface and/or portion thereof. According to some embodiments, the disabling mechanism may be positioned in contact with and/or within (e.g., within a void, detent, latch or keyhole, etc.) the target feature. In some embodiments, such as to reduce the possibility of damage to the unmanned vehicle and/or to decrease dwell time that is likely to activate a countermeasure device, the coupling mechanism and/or the disabling device may be deployed as payload from the unmanned vehicle and the unmanned vehicle may maneuver away from the target feature. According to some embodiments, the entire maneuver may comprise a quick advancement, coupling, and exit of the unmanned vehicle, leaving behind at least the disabling device. In some embodiments, the disabling device may be activated upon coupling, upon exiting of/disengagement from the unmanned vehicle, based on a timer, based on a remote trigger (e.g., signal), and/or based on one or more other triggering events (e.g., movement of the target feature, use of the target feature, an attempt to remove the disabling device, etc.).

In some embodiments, the method 400 may comprise determining whether there are more target features, at 420. In the case that the unmanned vehicle has the capability to engage/disable multiple target features, for example, the unmanned vehicle may cycle to engagement with the next target feature on a listing (e.g., ranked and/or prioritized) of target features, e.g., identified in the target area/location, and/or may otherwise search for additional target features. According to some embodiments, in the case that more target features exist, the method 400 may loop back and/or proceed to searching the target for additional target features, at 410. In the case that no more target features exist (and/or payload and/or munition stores have been depleted and no additional target features can accordingly be engaged), the method 400 may comprise and/or proceed to determining whether there are more targets, at 422. In the case that the unmanned vehicle has the capability to engage/disable multiple targets, for example (but all features of a first target have been disabled), the unmanned vehicle may cycle to engagement with the next target on a listing (e.g., ranked and/or prioritized) of targets, e.g., identified in the target area/location, and/or may otherwise search for additional targets. According to some embodiments, in the case that more targets exist, the method 400 may loop back and/or proceed to searching the target location for additional targets, at 406. In the case that no more targets exist (and/or payload and/or munition stores have been depleted and no additional targets can accordingly be engaged), the method 400 may comprise and/or proceed to navigating to a friendly location, at 424. The unmanned vehicle may depart the target location and/or area, for example, such as to refuel, recharge, repair, and/or resupply.

According to some embodiments, the method 400 may also or additionally comprise acquiring date descriptive of the disablement of the target feature(s). The unmanned vehicle may capture imagery and/or other data descriptive of the target feature before and/or after the disabling, for example, such as to document and/or measure the effectiveness of the maneuver/mission.

### IV. Targeted Operational Disablement Apparatus & Articles of Manufacture

Turning to FIG. 5, a block diagram of an apparatus 510 according to some embodiments is shown. In some embodiments, the apparatus 510 may be similar in configuration and/or functionality to one or more of the unmanned vehicles 110, remote server 130, and/or drones 210, 310a-e, of FIG. 1, FIG. 2A, FIG. 2B, FIG. 2C, FIG. 2D, FIG. 2E, and/or FIG. 3B herein. The apparatus 510 may, for example, execute, process, facilitate, and/or otherwise be associated with the method 400 of FIG. 4 herein, and/or portions thereof. In some embodiments, the apparatus 510 may comprise a processing device 512, a communication device 514, an input device 516, an output device 518, an interface 520, a memory device 540 (storing various programs and/or instructions 542 and data 544), and/or a coupling device 550. According to some embodiments, any or all of the components 512, 514, 516, 518, 520, 540, 542, 544, 550 of the apparatus 510 may be similar in configuration and/or functionality to any similarly named and/or numbered components described herein. Fewer or more components 512, 514, 516, 518, 520, 540, 542, 544, 550 and/or various configurations of the components 512, 514, 516, 518, 520, 540, 542, 544, 550 may be included in the apparatus 510 without deviating from the scope of embodiments described herein.

According to some embodiments, the processor 512 may be or include any type, quantity, and/or configuration of processor that is or becomes known. The processor 512 may comprise, for example, an Intel® IXP 2800 network processor or an Intel® XEON™ Processor coupled with an Intel® E7501 chipset. In some embodiments, the processor 512 may comprise multiple inter-connected processors, microprocessors, and/or micro-engines. According to some embodiments, the processor 512 (and/or the apparatus 510 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 510 comprises a server, such as a blade server or a virtual co-location device, necessary power may be supplied via a standard AC outlet, power strip, surge protector, and/or Uninterruptible Power Supply (UPS) device.

In some embodiments, the communication device 514 may comprise any type or configuration of communication device that is or becomes known or practicable. The communication device 514 may, for example, comprise a Network Interface Card (NIC), a telephonic device, a cellular network device, a router, a hub, a modem, and/or a communications port or cable. In some embodiments, the communication device 514 may be coupled to receive target location data, e.g., from a sensor device (not separately shown in FIG. 5). The communication device 514 may, for example, comprise a BLE and/or RF receiver device and/or a camera or other imaging device that acquires data from descriptive of a location and/or a target and/or a transmitter device that provides the data to a remote server and/or server or communications layer (not separately shown in FIG. 5). According to some embodiments, the communication device 514 may also or alternatively be coupled to the processor 512. In some embodiments, the communication device 514 may comprise an IR, RF, Bluetooth™ Near-Field Communication (NFC), and/or Wi-Fi® network device coupled to facilitate communications between the processor 512 and another device (such as a remote user device, e.g., a tele-operations station, not separately shown in FIG. 5).

In some embodiments, the input device 516 and/or the output device 518 are communicatively coupled to the processor 512 (e.g., via wired and/or wireless connections and/or pathways) and they may generally comprise any types or configurations of input and output components and/or devices that are or become known, respectively. The input device 516 may comprise, for example, a keyboard that allows an operator of the apparatus 510 to interface with the apparatus 510 (e.g., by maintenance and/or armament personnel). In some embodiments, the input device 516 may comprise a sensor, such as a camera, sound, light, radar, RF, and/or proximity sensor, configured to measure and/or record values via signals to the apparatus 510 and/or the processor 512. The output device 518 may, according to some embodiments, comprise a display screen and/or other practicable output component and/or device. The output device 518 may, for example, provide an interface (such as the interface 520) via which functionality for targeted operational disablement is provided to a user (e.g., via a mobile device application). According to some embodiments, the input device 516 and/or the output device 518 may comprise and/or be embodied in a single device, such as a touch-screen monitor. In some embodiments, the output device 518 may comprise a disabling device such as a shaped charge and/or other munition operable to disable a target feature, as described herein.

The memory device 540 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of navigation instructions 542-1, targeting instructions 542-2, coupling instructions 542-3, disabling instructions 542-4, interface instructions 542-5, location data 544-1, movement data 544-2, and/or sensor data 544-3. In some embodiments, the navigation instructions 542-1, targeting instructions 542-2, coupling instructions 542-3, disabling instructions 542-4, interface instructions 542-5, location data 544-1, movement data 544-2, and/or sensor data 544-3 may be utilized by the processor 512 to provide output information via the output device 518 and/or the communication device 514.

According to some embodiments, the navigation instructions 542-1 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the navigation instructions 542-1. In some embodiments, location data 544-1, movement data 544-2, and/or sensor data 544-3 may be fed by the processor 512 through one or more mathematical and/or statistical formulas and/or models in accordance with the navigation instructions 542-1 to cause an unmanned vehicle to navigate from a first location to a target location, as described herein.

In some embodiments, the targeting instructions 542-2 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the targeting instructions 542-2. In some embodiments, location data 544-1, movement data 544-2, and/or sensor data 544-3 may be fed by the processor 512 through one or more mathematical and/or statistical formulas and/or models in accordance with the targeting instructions 542-2 to cause an unmanned vehicle to identify one or more targets and/or target features, as described herein.

According to some embodiments, the coupling instructions 542-3 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the coupling instructions 542-3. In some embodiments, location data 544-1, movement data 544-2, and/or sensor data 544-3 may be fed by the processor 512 through one or more mathematical and/or statistical formulas and/or models in accordance with the coupling instructions 542-3 to cause an unmanned vehicle to maneuver to and/or couple with a target feature, as described herein.

In some embodiments, the disabling instructions 542-4 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the disabling instructions 542-4. In some embodiments, location data 544-1, movement data 544-2, and/or sensor data 544-3 may be fed by the processor 512 through one or more mathematical and/or statistical formulas and/or models in accordance with the disabling instructions 542-4 to cause an unmanned vehicle to disable the operational capability of a target by selectively damaging a target feature thereof, as described herein.

According to some embodiments, the interface instructions 542-5 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the interface instructions 542-5. In some embodiments, location data 544-1, movement data 544-2, and/or sensor data 544-3 may be fed by the processor 512 through one or more mathematical and/or statistical formulas and/or models in accordance with the interface instructions 542-5 to generate an interface that permits user input into a targeted operational disablement system.

In some embodiments, the apparatus 510 may comprise the coupling device 550. The coupling device 550 may comprise, for example, any type and/or configuration of device that is operable to properly position an unmanned vehicle (e.g., the apparatus 510) with respect to a target feature (not shown) and/or to removably or permanently attach the unmanned vehicle to the target feature. In such a manner, for example, a disabling device (not shown) may be advantageously positioned adjacent to and/or in contact with the target feature and may act thereupon to disable the target feature, as described herein. The coupling device 550 may comprise, for example, one or more claws, pincers, grippers, magnets, adhesives, welding, fusing, and/or screwing devices.

According to some embodiments, the apparatus 510 may comprise a cooling device (not shown). According to some embodiments, the cooling device may be coupled (physically, thermally, and/or electrically) to the processor 512 and/or to the memory device 540. The cooling device may, for example, comprise a fan, heat sink, heat pipe, radiator, cold plate, and/or other cooling component or device or combinations thereof, configured to remove heat from portions or components of the apparatus 510.

Any or all of the exemplary instructions and data types described herein and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 510. According to some embodiments, the memory device 540 may be incorporated into and/or otherwise coupled to the apparatus 510 (e.g., as shown) or may simply be accessible to the apparatus 510 (e.g., externally located and/or situated).

Referring to FIG. 6A, FIG. 6B, FIG. 6C, FIG. 6D, and FIG. 6E, perspective diagrams of exemplary data storage devices 640a-e according to some embodiments are shown. The data storage devices 640a-e may, for example, be utilized to store instructions and/or data such as the navigation instructions 542-1, targeting instructions 542-2, coupling instructions 542-3, disabling instructions 542-4, interface instructions 542-5, location data 544-1, movement data 544-2, and/or sensor data 544-3, each of which is presented in reference to FIG. 5 herein. In some embodiments, instructions stored on the data storage devices 640a-e may, when executed by a processor, cause the implementation of and/or facilitate the methods 400 of FIG. 4 herein, and/or portions thereof.

According to some embodiments, the first data storage device 640a may comprise one or more various types of internal and/or external hard drives. The first data storage device 640a may, for example, comprise a data storage medium 646 that is read, interrogated, and/or otherwise communicatively coupled to and/or via a disk reading device 648. In some embodiments, the first data storage device 640a and/or the data storage medium 646 may be configured to store information utilizing one or more magnetic, inductive, and/or optical means (e.g., magnetic, inductive, and/or optical-encoding). The data storage medium 646, depicted as a first data storage medium 646a for example (e.g., breakout cross-section “A”), may comprise one or more of a polymer layer 646a-1, a magnetic data storage layer 646a-2, a non-magnetic layer 646a-3, a magnetic base layer 646a-4, a contact layer 646a-5, and/or a substrate layer 646a-6. According to some embodiments, a magnetic read head 648a may be coupled and/or disposed to read data from the magnetic data storage layer 646a-2.

In some embodiments, the data storage medium 646, depicted as a second data storage medium 646b for example (e.g., breakout cross-section “B”), may comprise a plurality of data points 646b-2 disposed with the second data storage medium 646b. The data points 646b-2 may, in some embodiments, be read and/or otherwise interfaced with via a laser-enabled read head 648b disposed and/or coupled to direct a laser beam through the second data storage medium 646b.

In some embodiments, the second data storage device 640b may comprise a CD, CD-ROM, DVD, Blu-Ray™Disc, and/or other type of optically-encoded disk and/or other storage medium that is or becomes know or practicable. In some embodiments, the third data storage device 640c may comprise a USB keyfob, dongle, and/or other type of flash memory data storage device that is or becomes know or practicable. In some embodiments, the fourth data storage device 640d may comprise RAM of any type, quantity, and/or configuration that is or becomes practicable and/or desirable. In some embodiments, the fourth data storage device 640d may comprise an off-chip cache such as a Level 2 (L2) cache memory device. According to some embodiments, the fifth data storage device 640e may comprise an on-chip memory device such as a Level 1 (L1) cache memory device.

The data storage devices 640a-e depicted in FIG. 6A, FIG. 6B, FIG. 6C, FIG. 6D, and FIG. 6E are representative of a class and/or subset of computer-readable media that are defined herein as “computer-readable memory” (e.g., non-transitory memory devices as opposed to transmission devices or media). The data storage devices 640a-e may generally store program instructions, algorithms, software engines, code, and/or modules that, when executed by a processing device cause a particular machine to function in accordance with one or more embodiments described herein.

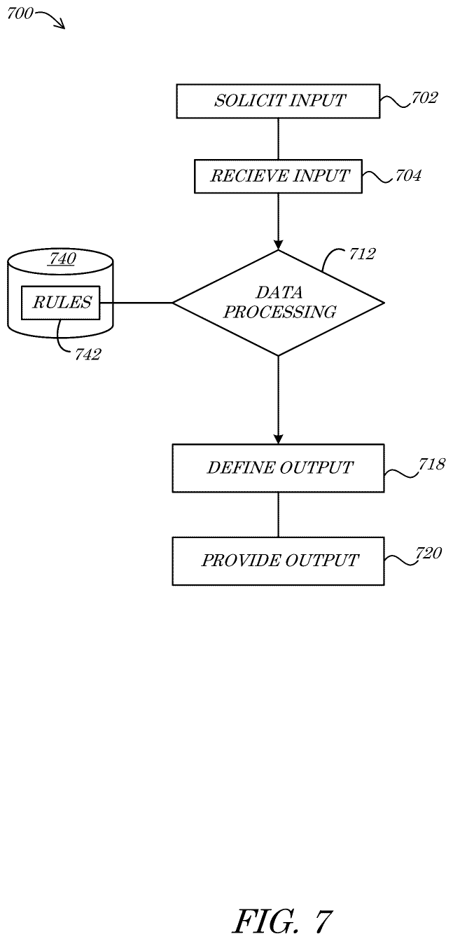

With reference to FIG. 7, for example, the data storage devices 640a-e may store and/or define an algorithm 700. The algorithm 700 may comprise, for example, one or more software programs, modules, engines, and/or applications coded to perform the method 400 of FIG. 4, and/or portions thereof. The algorithm 700, and any reference to the term “algorithm” herein, refers to any set of defined instructions that operate upon input to define and/or provide output. The algorithm 700 may, for example, be specifically programmed and/or otherwise defined to instruct a computer or other device (not shown) to solve a particular problem (e.g., logical) and/or resolve a particular mathematical calculation (e.g., arithmetic). In some embodiments, the algorithm 700 may be written and/or defined as a series or sequence of instructions encoded in (e.g., written in accordance with syntax and/or semantics rules) a particular computer programming language (e.g., Python™, Java™, JavaScript™, C, C++, C#, Basic™, FORTRAN, COBOL, Ruby™, and/or Perl™), e.g., a set of instructions that convert and/or encode characters, objects, and/or other data elements into machine code (e.g., code operable to be executed by an electronic processing device such as a CPU).

According to some embodiments, the algorithm 700 may comprise soliciting input, at 702. Input from one or more sources may be searched for and/or queried, by structuring and/or executing a database query and/or by sending a data communication signal or “handshake”, such as is common with Bluetooth® short-range communication protocols. In some embodiments, the algorithm 700 may comprise receiving the input, at 704. Whether solicited or otherwise provided and/or acquired (e.g. loaded and/or downloaded), for example, the input for the algorithm 700 may be received, identified, and/or otherwise processed and/or located. According to some embodiments, the algorithm 700 may comprise data processing, at 712. The data processing 712 may, for example, comprise execution of one or more logical and/or computational procedures, modules, scripts, and/or routines that may be stored in a memory device 740 (e.g., similar to the data storage devices 640a-e) as a set of instructions or rules 742 and/or that may defined and/or implemented by one or more electrical, mechanical, and/or physical components, such as logic gates, diodes, transistors, relays, and/or switches (e.g., operable to execute the method 400 of FIG. 4 herein, and/or portions thereof).

In some embodiments, execution of the algorithm 700 may comprise a loading of the rules 742 into the memory 740 and/or into an electronic processing system (not shown) and/or an activation of one or more logic gates and/or other electrical and/or mechanical components. The algorithm 700 may operate upon the input in accordance with the rules 742 to achieve a result by defining output, at 718. The algorithm 700 may, for example, generate, produce, define, identify, calculate, and/or otherwise compute output based on an application of the data processing 712 utilizing the rules 742 and any or all input receiving at 704. According to some embodiments, the algorithm 700 may comprise providing the output, at 720. One or more output devices (not shown) may be utilized to convey the output (e.g., a result, conclusion, decision, etc.) to one or more other devices and/or entities (not shown), such as one or more users, consumers, customers, potential customers, and/or devices utilized thereby. The output may be displayed via an electronic display screen of a computer, mobile/smart phone, smart watch, etc., and/or may be transmitted as one or more electronic signals to one or more network destination addresses, such as e-mail addresses, URL locations, MAC addresses, and/or broadcast radio frequencies.

According to some embodiments, the data processing at 712 may comprise execution of a listing, sequence, matrix, and/or other set of stored steps and/or instructions that utilize the input to define the output. In some embodiments, the listing of steps and/or instruction details may comprise elements that are known to those skilled in the art. The algorithm 700 may partially or completely comprise, for example, instructions and/or steps that are well known, such as steps and/or instructions operable to calculate an area (length times width), volume (length times width times height), distance (difference between two locations), velocity (distance over time), acceleration (velocity over time), and/or any other known mathematical and/or logical (if/then statements) procedures. For any and all known procedures and/or instructions, the discrete details of such instructions are represented by the data processing at 712 and are not listed herein as one of ordinary skill in the art would readily comprehend both what such technological knowledge entails and that the inventor has possession of such knowledge. Instructions that may be included within and/or comprise the data processing at 712 (and/or the algorithm 700) may include, for example, but are not limited to, any known or practicable: (i) OCR algorithms, (ii) GUI object behavior algorithms, (iii) data transmission algorithms, (iv) data encoding algorithms, (v) data decoding algorithms, (vii) logical and/or mathematical data comparison algorithms, and (viii) data searching (e.g., keyword searching) algorithms.

### V. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

As used herein, the term “coupled” may generally refer to any type or configuration of coupling that is or becomes known or practicable. Coupling may be descriptive, for example, of two or more objects, devices, and/or components that are communicatively coupled, mechanically coupled, electrically coupled, and/or magnetically coupled. The term “communicatively coupled” generally refers to any type or configuration of coupling that places two or more objects, devices, components, or portions, elements, or combinations thereof in communication. Mechanical, electrical, fluid, and magnetic communications are examples of such communications. The term “mechanically coupled” generally refers to any physical binding, adherence, attachment, and/or other form of physical contact between two or more objects, devices, components, or portions, elements, or combinations thereof. The term “electrically coupled” indicates that one or more objects, devices, components, or portions, elements, or combinations thereof, are in electrical contact such that an electrical signal, pulse, or current (e.g., electrical energy) is capable of passing between the one or more objects, enabling the objects to electrically communicate with one another. In some embodiments, electrical coupling may enable electrical energy to be transmitted wirelessly between two or more objects and/or devices. The term “magnetically coupled” indicates that one or more objects, devices, components, or portions, elements, or combinations thereof, are within one or more associated magnetic fields. Objects may be electrically and/or magnetically coupled without themselves being physically attached or mechanically coupled. For example, objects may communicate electrically through various wireless forms of communication or may be within (at least partially) a magnetic field, without being physically touching or even adjacent.

References to “interior” or “exterior” are references to areas and/or portions of an object with respect to other features such as holes, volumes, ports, passages, conduits, etc. Such objects necessarily comprise and/or define various “surfaces” such as an interior, exterior, inner, outer, inside, and/or outside surface. References to the different areas and/or portions are accordingly also references to the associated surfaces.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including ten percent (10%) of that value are intended, unless explicitly stated otherwise.

Directions and other relative references may be used to facilitate discussion of the drawings and principles herein, but are not intended to be limiting. For example, certain terms may be used such as “inner,” “outer,”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The indefinite articles “a” and “an,” as used herein in the specification and in the claims, unless clearly indicated to the contrary, should be understood to mean “at least one” or “one or more”.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As utilized herein, the terms “program” or “computer program” may refer to one or more algorithms formatted for execution by a computer. The term “module” or “software module” refers to any number of algorithms and/or programs that are written to achieve a particular output and/or output goal—e.g., a ‘login credentialing’ module (or program) may provide functionality for permitting a user to login to a computer software and/or hardware resource and/or a ‘shipping’ module (or program) may be programmed to electronically initiate a shipment of an object via a known and/or available shipping company and/or service (e.g., FedEX®). The terms “engine” or “software engine” refer to any combination of software modules and/or algorithms that operate upon one or more inputs to define one or more outputs in an ongoing, cyclical, repetitive, and/or loop fashion. Data transformation scripts and/or algorithms that query data from a data source, transform the data, and load the transformed data into a target data repository may be termed ‘data transformation engines’, for example, as they repetitively operate in an iterative manner upon each row of data to produce the desired results.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. A system for targeted operational disablement of a target feature, comprising:
an electronic processing device;
a sensor device in communication with the electronic processing device;
a propulsion device in communication with the electronic processing device;
a coupling device in communication with the electronic processing device;
a disabling device in communication with the electronic processing device; and
a non-transitory data storage device in communication with the electronic processing device, the non-transitory data storage device storing predefined target acquisition data and instructions that when executed by the electronic processing device, result in:
acquiring, by the sensor device, target data descriptive of a target location;
identifying, by comparing the target data to the predefined target acquisition data, at least one target;
identifying, by comparing a subset of the target data that corresponds to the target to the predefined target acquisition data, at least one target feature;
maneuvering, by selectively activating the propulsion device, the coupling device to the target feature;
coupling, by activating the coupling device, to the target feature; and
disabling, by activating the disabling device, the target feature.

2. The system for targeted operational disablement of a target feature of claim 1, wherein the non-transitory data storage device further stores navigational routing instructions that when executed by the electronic processing device, further result in:
plotting, by an execution of the navigational routing instructions, a route from a starting location to the target location; and
maneuvering, by selectively activating the propulsion device and in accordance with the plotted route, from the starting location to the target location.

3. The system for targeted operational disablement of a target feature of claim 1, wherein the instructions, when executed by the electronic processing device, further result in:
identifying a friendly location remote from the target location; and
maneuvering, after the disabling and by selectively activating the propulsion device, from the target location to the identified friendly location.

4. The system for targeted operational disablement of a target feature of claim 1, wherein the sensor device comprises a LiDAR device and wherein the predefined target acquisition data comprises a geometric signature of at least one of the target and the target feature.

5. The system for targeted operational disablement of a target feature of claim 1, wherein the sensor device comprises a thermal imaging device and wherein the predefined target acquisition data comprises a thermal signature of at least one of the target and the target feature.

6. The system for targeted operational disablement of a target feature of claim 1, wherein the sensor device comprises a visual imaging device and wherein the predefined target acquisition data comprises a visual object signature of at least one of the target and the target feature.

7. The system for targeted operational disablement of a target feature of claim 1, wherein the at least one target comprises at least one of a tank and an artillery vehicle.

8. The system for targeted operational disablement of a target feature of claim 7, wherein the at least one target feature comprises at least one of a main gun barrel, a munitions store, a crew hatch, and an engine compartment.

9. The system for targeted operational disablement of a target feature of claim 1, wherein the propulsion device comprises (i) a set of motorized rotors and (ii) ground-engaging treads.

10. The system for targeted operational disablement of a target feature of claim 1, wherein the coupling device comprises a claw.

11. The system for targeted operational disablement of a target feature of claim 1, wherein the coupling device comprises at least one bistable spring band.

12. The system for targeted operational disablement of a target feature of claim 1, wherein the coupling device comprises a magnetic mounting device.

13. The system for targeted operational disablement of a target feature of claim 1, wherein the disabling device comprises a shaped charge.

14. The system for targeted operational disablement of a target feature of claim 1, wherein the disabling device comprises a thermite delivery device.

15. The system for targeted operational disablement of a target feature of claim 1, wherein the maneuvering comprises:
selecting, from a plurality of available maneuvers and based on the target data descriptive of the target location, at least one maneuver to execute; and
maneuvering, in accordance with the at least one selected maneuver, by selectively activating the propulsion device.

16. The system for targeted operational disablement of a target feature of claim 15, wherein the at least one selected maneuver comprises a plurality of maneuvers that define a path of travel from a current location to the target feature.

17. The system for targeted operational disablement of a target feature of claim 15, wherein target data descriptive of the target location comprises data descriptive of a characteristic of the at least one target.
